(19) United States
(12) Patent Application Publication
(10) Pub. No.: US 2008/0030592 A1
(43) Pub. Date: Feb. 7, 2008

(54) PRODUCING DIGITAL IMAGE WITH DIFFERENT RESOLUTION PORTIONS

(75) Inventors: John N. Border, Walworth, NY (US); Scott C. Cahall, Fairport, NY (US); John D. Griffith, Rochester, NY (US)

Correspondence Address: EASTMAN KODAK COMPANY;PATENT LEGAL STAFF, 343 STATE STREET, ROCHESTER, NY, 14650-2201, US

(73) Assignee: Eastman Kodak Company

(21) Appl. No.: 11/461,574

(22) Filed: Aug. 1, 2006

(51) Int. Cl. G06T 5/50

(52) U.S. Cl. 348/218.1; 348/E05.028

(57) ABSTRACT

A method of producing a digital image with improved resolution during digital zooming, including simultaneously capturing a first low resolution digital image of a scene and a second higher resolution digital image of a portion of substantially the same scene. A composite image is then formed by combining the first low-resolution digital image and a corresponding portion of the high resolution digital image. Digital zooming of the composite image produces a zoomed image with high resolution throughout the zoom range and improved image quality.

### CROSS REFERENCE TO RELATED APPLICATIONS

Reference is made to commonly assigned U.S. Patent Application Serial No. 2002/0075258, filed Nov. 23, 2001, entitled “Camera System with High Resolution Image Inside a Wide Angle View” by Park et al. and U.S. patent application Ser. No. 11/062,174, filed Feb. 18, 2005, entitled “Digital Camera Using Multiple Lenses And Image Sensors To Provide An Extended Zoom Range” by Peter Labaziewicz, et al., the disclosures of which are incorporated herein.

### FIELD OF THE INVENTION

The present invention relates to a digital camera that uses multiple lenses and image sensors to provide an extended zoom range and the method used to produce a digital image that combines the multiple images produced by the digital camera.

### BACKGROUND OF THE INVENTION

Currently, most digital cameras use a zoom lens and a single color image sensor to capture still and motion images. The captured images are then digitally processed to produce digital image files, which are stored in a digital memory in the camera. The digital image files can then be transferred to a computer, displayed, and shared via the Internet. The digital camera can be included as part of a mobile telephone, to form a so-called “camera phone.” The camera phone can transmit the digital image files to another camera phone, or to service providers, via a mobile telephone network.

Small camera size and a large zoom range are two very important features of digital cameras. Users prefer to have a large zoom range (e.g. 5:1 or greater) rather than a limited zoom range (e.g. 3:1 or smaller). The zoom range is typically composed of both optical zoom which is provided by variable focal length lenses and digital zoom which is provided by a magnification of the digital image after capture. Variable focal length lenses for large zoom range are expensive and they increase the size of the digital camera. Thus, there are trade-off's between small camera size, large zoom range, and low camera cost which must be made when designing a digital camera. With higher cost cameras, such as single lens reflex cameras, these problems are sometimes addressed by using multiple interchangeable zoom lenses, such as two 3:1 zoom lenses, e.g., a 28-70 mm zoom and a 70-210 zoom. This arrangement has user inconvenience problems and is presently not available for low cost digital cameras.

A different solution that has been offered by Kodak in the V570 and the V610 cameras is to include two different lens assemblies in the camera with two different focal lengths and two separate image sensors. In this case, each of the lens assemblies can be either a fixed focal length lens or can have a moderate optical zoom range to reduce the size and cost of each of the lens assemblies. Together, the two lens assemblies provide a wide zoom range and a small overall size at a lower cost. However, a problem arises when the focal length of the first lens does not match the focal length of the second lens so that the optical zoom is not continuous over the entire zoom range. In this case, digital zoom must be used for zoom between the maximum zoom of the first lens and the minimum zoom of the second lens.

Digital zoom based on increased magnification of the image with a corresponding decrease in resolution is well known in the art. Although digital zoom is very fast and simple, the decrease in resolution can produce a perceived decrease in image quality.

In U.S. Pat. No. 5,657,402, a method is described in which a plurality of digital images are combined to form an image. U.S. Pat. No. 5,657,402 addresses the use of multiple images captured at different times wherein “the plurality of images of various focal lengths, such as a zoom video sequence” (col. 1, lines, 21-22) are captured from the same lens. U.S. Pat. No. 5,657,402 does not address two lens assemblies simultaneously capturing images of the same scene.

In US Publication No. 2002/0075258, a panoramic camera system is described in which a moveable telephoto camera is additionally used to capture a high-resolution portion of the scene which is then overlaid onto the panoramic image. US Publication No. 2002/0075258 describes the use of a moveable telephoto camera to enable a higher resolution of a portion of the image wherein the moveable telephoto camera can be moved to the region of the panoramic image where the higher resolution is desired. US Publication No. 2002/0075258 does not address the case wherein a wide-angle camera and a telephoto camera are affixed together for simultaneous capture of the same scene. In addition, US Publication No. 2002/0075258 does not disclose the use of a composite image for improved image quality in a digital zoom system.

### SUMMARY OF THE INVENTION

The present invention provides a sufficiently compact, low cost, optical system with a large zoom range for a small, lightweight and relatively inexpensive consumer digital camera.

What is therefore needed is a digital camera that provides a rapidly-operating extended zoom range without unduly increasing the size or cost of the digital camera while providing good perceived image quality throughout the zoom range.

An object of the invention is to provide a method of producing a digital image having portions with different resolutions comprising:

a. simultaneously capturing first and second digital images of the same scene wherein the first digital image is of a larger portion of the scene than the second digital image wherein the second digital image has a higher resolution than the resolution in the first digital image corresponding to the second digital image; and

b. combining at least a portion of the second digital image into the corresponding portion of the first digital image to thereby provide a digital image having portions with different resolutions.

The present invention is directed to overcoming the problems set forth above. Briefly summarized, the invention includes an electronic camera for producing an image of a scene, wherein the camera includes a first image sensor for generating a first sensor output, a first lens with a first focal length for forming a first image of the scene on the first image sensor, a second image sensor for generating a second sensor output, and a second lens with a second focal length that is longer than the focal length of the first lens for forming a second image of the same scene on the second image sensor. The first lens or the second lens can be either fixed focal length lenses or multiple focal length lenses as in a zoom lens wherein, the first and second lenses are directed at substantially the same scene and image sets are captured substantially simultaneously by the first image sensor and the second image sensor. Portions of the image set captured by the first image sensor and the second image sensor are then combined to produce a composite image with a higher resolution in the portion of the composite image that is provided by the second image sensor due to the longer focal length of the second lens. Subsequent images produced during a digital zooming process are composed largely of the lower resolution image captured by the first image sensor at low digital zoom values and largely of the higher resolution image as captured by the second image sensor at high digital zoom values.

By forming a composite image with portions of the image from the short focal length lens and portions of the image from the longer focal length lens, perceived image quality is improved throughout the zoom range while lens complexity is reduced, since a continuous zoom ratio can be produced with unmatched lens focal lengths. By capturing images from the two image sensors substantially simultaneously, complexities in the image processing are reduced since differences between the two images due to motion of the camera or motion within the scene are avoided. It is an additional advantage, that the present invention can avoid the slow response that is typical of an optical zoom system when traversing a large zoom range.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIGS. 1A and 1B depict a block diagram of a digital camera using a fixed focal length wide-angle lens with a first image sensor and a zoom lens, or a longer second fixed focal length lens, with a second image sensor according to the present invention;

FIGS. 2A and 2B show front and rear perspective views of the digital camera;

FIGS. 3A and 3B are perspective views of the front and back of a cell phone including a camera with multiple lenses and multiple sensors according to the present invention;

FIGS. 4A and 4B show two views of the capture assembly used in the cell phone shown in FIGS. 3A and 3B

FIG. 5 is a block diagram of the stitching process to create the composite image;

FIG. 6 depicts a wide angle image as captured, a telephoto image as captured, and a composite image as created by the invention; and

FIG. 7 is a block diagram of the stitching process with video images to create a composite video.

### DETAILED DESCRIPTION OF THE INVENTION

Because digital cameras employing imaging devices and related circuitry for signal capture, correction, and exposure control are well known, the present description will be directed in particular to elements forming part of, or cooperating more directly with, method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

In the image capture device that is the subject of the invention, two or more lens systems are associated with a respective number of image sensors. The lenses have different focal lengths and different fields of view within the same scene wherein the field of view of the longer focal length lenses contains at least a portion of the field of view of the shorter focal length lens. In addition, the image captured by the image sensor associated with the longer focal length lens has a higher resolution than the image captured by the image sensor associated with the lens with the shorter focal length.

In the embodiment of the invention, the image capture done by the two or more image sensors is done substantially simultaneously so that motion artifacts from motion of the camera or motion within the scene, do not cause differences in the two or more images that are captured. The invention discloses the use of the two or more images to form a composite image that includes portions of each of the two or more images for the purpose of providing a digitally zoomed image with uniformly high resolution.

Each of the several embodiments of the present invention include an image capture assembly having multiple lenses and multiple image sensors mounted within a digital camera wherein the multiple lenses have different focal lengths and portions of the fields of view are substantially the same and the multiple image sensors can capture images simultaneously. The invention describes an arrangement for producing an image that is formed by combining the images from the multiple image sensors in a way that provides increased resolution in a digitally zoomed image.

In each embodiment, the camera captures images from the multiple image sensors simultaneously. Each multiple lens system contains at least one fixed focal length lens or variable focal length lens as in an optical zoom lens. Moreover, each embodiment includes some type of user control that allows a user to select a zoom amount, which controls both the digital zoom and the optical zoom lens if present. In some embodiments, a single “zoom lens” user control is used. e.g., where the “wide” setting selects a wide angle fixed focal length lens and the “tele” setting(s) select various positions of a zoom lens. In any case, digital zooming is used along with any optical zoom that is present to provide a continuous zoom “up” from the image obtained with the short focal length lens to the maximum focal length of the multiple lenses. All this, of course, can be transparent to the user, who simply manipulates the “zoom” user control between the “wide” and “tele” settings.

The composite image can be formed during image processing on the camera or later during post processing when the images have been offloaded from the camera. In either case, the two images must be matched to locate the high-resolution image accurately into the low-resolution image and then stitched into place so the edge between the two images in the composite image is not discernible. To enable the composite image to be formed during post processing, both images in the image set must be stored at the time of image capture. In the case of video, by storing the low-resolution video and the high resolution video, the zoom ratio can be selected after image capture and adjusted as desired at that time.

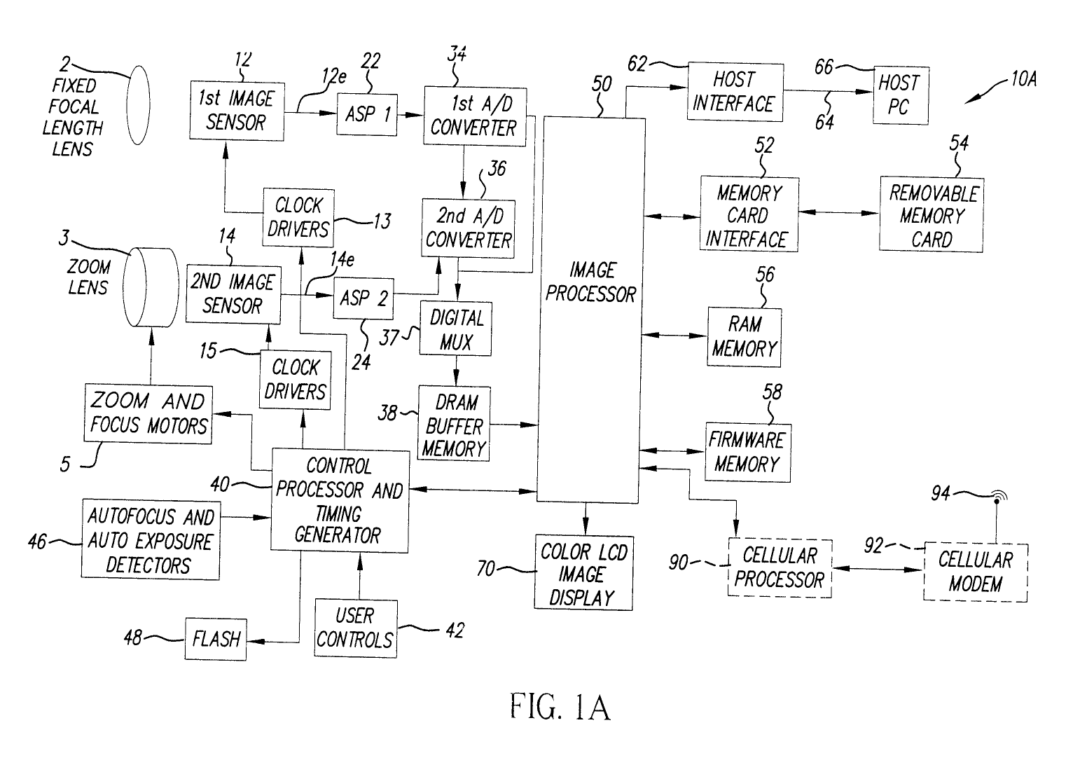

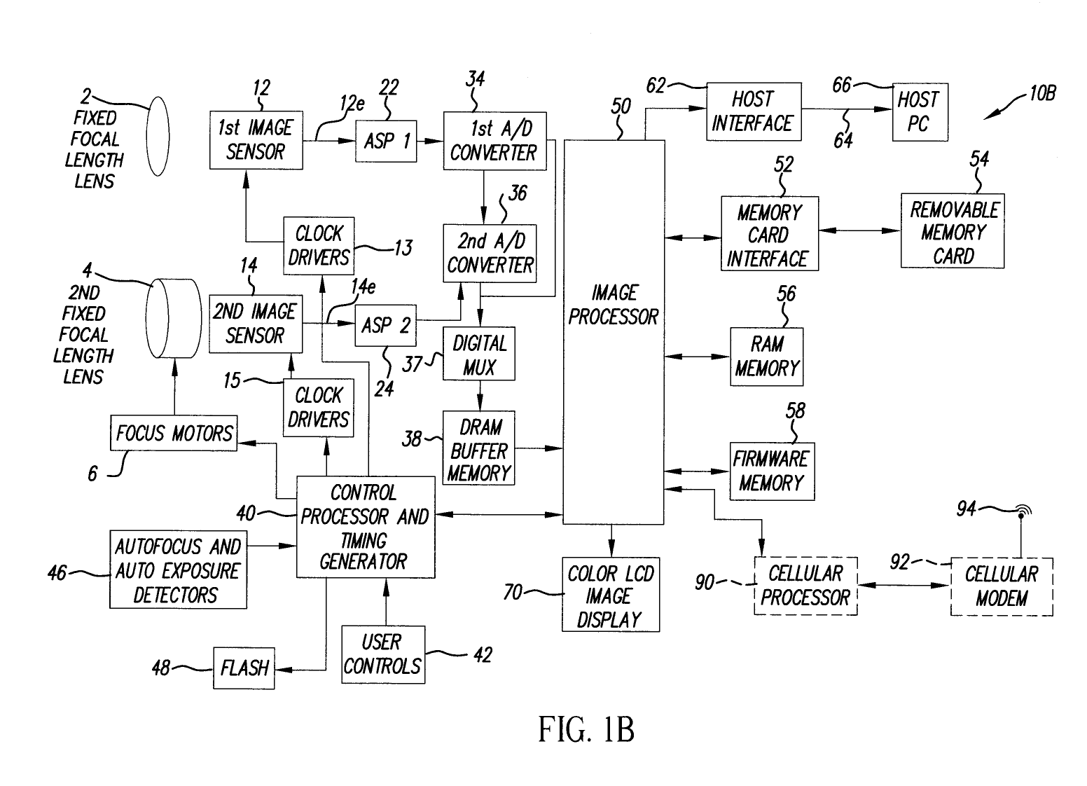

Turning now to FIG. 1A, a digital camera 10A is described which includes an image capture assembly, including a fixed focal length lens 2 that focuses an image of a scene (not shown) onto a first image sensor 12, and a zoom lens 3 which focuses an image of the scene onto a second image sensor 14. The image capture assembly 1 provides a first image output signal 12e from the first image sensor 12 and a second image output signal 14e from the second image sensor 14.

The focal length of the fixed focal length lens 2 generates a wide-angle field of view and has a fixed focus set to a distance near the lens hyperfocal distance of 8 feet so that objects from 4 feet to infinity are in focus. Therefore, the fixed focal length lens 2 does not need to include a focus adjustment. The fixed focal length lens 2 includes an adjustable aperture and shutter assembly to control the exposure of the first image sensor 12. The zoom lens 3 includes an optical zoom and autofocus controlled by zoom and focus motors 5 and an adjustable aperture and shutter assembly to control the exposure of the image sensor.

In a preferred embodiment, the image sensors 12 and 14 are single-chip color Megapixel CCD sensors, using the well-known Bayer color filter pattern to capture color images. The image sensors 12 and 14 can have, for example, a 4:3 image aspect ratio and a total of 3.1 effective megapixels (million pixels), with 2048 active columns of pixels×1536 active rows of pixels. The image sensors 12 and 14 can use a ½″ type optical format, so that each pixel is approximately 3.1 microns tall by 3.1 microns wide. A control processor and timing generator 40 controls the first image sensor 12 by supplying signals to clock drivers 13, and controls the second image sensor 14 by supplying signals to clock drivers 15.

The control processor and timing generator 40 also controls the zoom and focus motors 5 for zoom lens 3, and a flash 48 for emitting light to illuminate the scene. The control processor and timing generator 40 also receives signals from automatic focus and automatic exposure detectors 46. In an alternative embodiment, instead of using the automatic focus and automatic exposure detectors 46, the image sensor 14 could be used to provide exposure detection and “through-the-lens” autofocus, as described in commonly-assigned U.S. Pat. No. 5,668.597 entitled “Electronic Camera with Rapid Automatic Focus of an Image upon a Progressive Scan Image Sensor” which issued Sep. 26, 1997 in the names of Kenneth A. Parulski, Masaki Izumi, Seiichi Mizukoshi and Nobuyuki Mori, incorporated herein by reference. User controls 42 are used to control the operation of the digital camera 10A.

The first image output signal 12e from the first image sensor 12 is amplified by a first analog signal processor (ASP 1) 22 and provided to a first analog-to-digital (A/D) converter 34. The second image output signal 14e from the second image sensor 14 is amplified by a second analog signal processor (ASP 2) 24 and provided to a second A/D converter 36.

The digital data from the A/D converters 34 and 36 is provided to digital multiplexer 37. The digital multiplexer 37 is used to select which one of the outputs of the two A/D converters 34 and 36 is connected to the DRAM buffer memory 38. The digital data is stored in DRAM buffer memory 38 and subsequently processed by an image processor 50. The processing performed by the image processor 50 is controlled by firmware stored in fin-ware memory 58, which can be flash EPROM memory. The image processor 50 processes the input digital image file, which is buffered in a RAM memory 56 during the processing stage. The image processor 50 combines the digital data from the A/D converters 34 and 36 to form a composite image with areas of high resolution and areas of lower resolution using a method, which constitutes the invention.

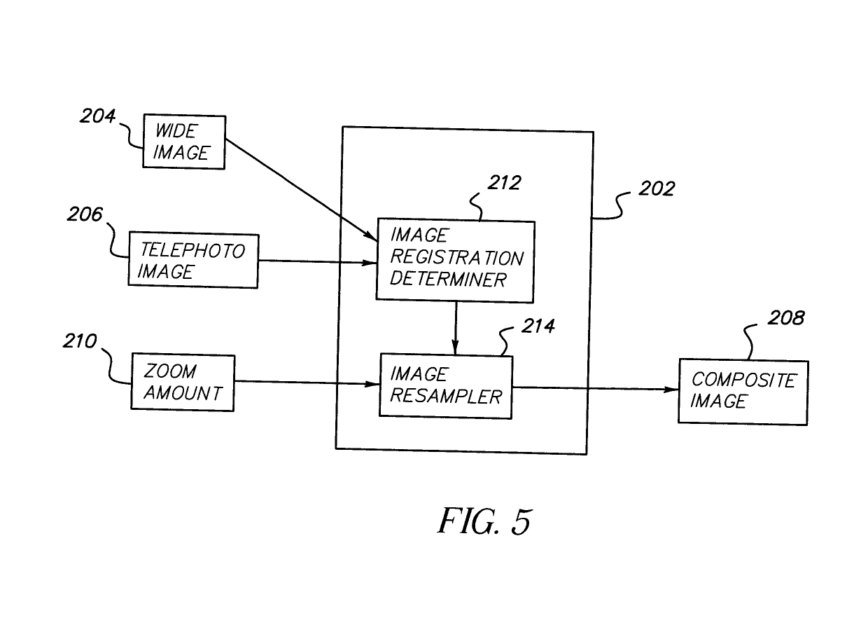

As shown in FIG. 5, the image processor 50 of FIGS. 1A and 1B contains an image compositor 202 that receives both the wide image 204 from the fixed focal length lens 2 and the telephoto image 206 from the zoom lens 3. The telephoto image 206 is of a smaller portion of the scene than the wide image 204, but captures this smaller portion with greater resolution than the resolution of the wide image 204. The image compositor 202 generates a composite image 208 using image data from both the wide image 204 and the telephoto image 206. Also, the image compositor 202 receives a zoom amount 210 that can be adjusted by the camera user as will be described below.

It is desirable for the image compositor 202 to generate a composite image 208 that has the highest possible quality. For illustration, assume that the wide image 204 and the telephoto image 206 have the same number of rows R and columns C of pixels, for example, R=1000 and C=1500 and that the relative magnification ratio M of the telephoto image 206 to the wide image 204 is M=3.

The image registration determiner 212 determines the registration between the wide image 204 and the telephoto image 206. The coordinate transformation is simply a translation and a scale because the image sensors that capture the wide image 204 and the telephoto image 206 are coplanar. A convenient way to represent the registration between the images is to find the mapping of the four corner pixels of the telephoto image 206 onto the wide image 204. For example,

| Telephoto Image Coordinates | Wide Image Coordinates |
|---|---|
| (0, 0) | (333, 499.7) |
| (999, 0) | (666, 499.7) |
| (0, 1499) | (333, 999.3) |
| (999, 1499) | (666, 999.3) |

### The registration can also be stored in the form of the homography H_{TW} that transforms the coordinates of the telephoto image 206 to the wide image 204.

$$[ \begin{matrix}{x}_{w} \\ {y}_{w} \\ 1\end{matrix} ] = {H}_{TW} [ \begin{matrix}{x}_{T} \\ {y}_{T} \\ 1\end{matrix} ]$$

### Where coordinates of the telephoto image 206 are in (row, column) notation (y_{T}, x_{T}) and coordinates of the wide image 204 are (y_{W}, x_{W}). For example,

$${H}_{TW} = [ \begin{matrix}1 / M & 0 & 499.7 \\ 0 & 1 / M & 333 \\ 0 & 0 & 1\end{matrix} ]$$

The correspondences between the coordinate systems represent the registration between the wide image 204 and the telephoto image 206. The correspondences are preferably determined at the time of manufacture by shooting test targets, as is well known in the art. If one or both of the lenses were a zoom lens rather than a fixed lens., the registration correspondences could still be determined at the time of manufacture as a function of the zoom position of the lenses. It should be further noted that while the example shows a pure translate and scale transformation, it may be necessary to correct for a difference in tilt between the two imaging systems.

Alternatively, the registration between images can be determined using the image information contained in the wide image 204 and telephoto image 204. This is well known in the art of image processing (for example, image registration is described in U.S. Pat. No. 6,078,701) and generally includes the steps of finding interest points in each image, making guesses at corresponding points (i.e. a scene feature that appears in both images), determining an initial guess at the registration, using that initial guess to refine the correspondence point guess, and so on based on comparing pixel values or contrast in the two images.

The image resampler 214 uses the registration information and the zoom amount 210 to produce the composite image 208. Preferably, the composite image has the same number of rows and columns of pixels as the wide image 204 and the telephoto image 206. However, it is well known to those skilled in the art that modifying the number of rows and columns of pixels (interpolating the image) can easily be done so that the image contains the desired number of pixels.

The zoom amount 210 Z specifies the desired relative zoom amount of the produced composite image 208. Preferably, when the value of Z=1, then the composite image is the wide image 204. On the other hand, when Z-M, then the composite image 208 is the telephoto image 206. When the zoom amount is between 1 and M, data from both the wide image 204 and the telephoto image 206 are used by the image resampler 214 to produce the composite image 208.

The image resampler 214 applies the zoom amount Z as follows: Each pixel position (y_{c}, x_{c}) of the composite image 208 is mapped to the coordinates of wide image 204 according to:

$$[ \begin{matrix}{x}_{W} \\ {y}_{W} \\ 1\end{matrix} ] = {H}_{CW} [ \begin{matrix}{x}_{C} \\ {y}_{C} \\ 1\end{matrix} ]$$

$$where$$

$${H}_{CW} = [ \begin{matrix}1 / Z & 0 & ( 1 - M ) ( C - 1 ) \\ 0 & 1 / Z & ( 1 - M ) ( C - 1 ) \\ 0 & 0 & 1\end{matrix} ]$$

In a similar manner, the position (y_{c}, x_{c}) of the composite image 208 is mapped to the coordinates of the telephoto image 206 using the equation:

$$[ \begin{matrix}{x}_{T} \\ {y}_{T} \\ 1\end{matrix} ] = {( {H}_{TW} )}^{- 1} {H}_{CW} [ \begin{matrix}{x}_{C} \\ {y}_{C} \\ 1\end{matrix} ]$$

Then, the pixel value of the composite image at position (y_{c}, x_{c}) is found by interpolation. If the mapped position of (y_{c}, x_{c}) in the telephoto image 206 lands within the limits of the existing pixels (i.e. 0<=x_{T}<=C-1), the pixel value of the composite image 208 at position (y_{c}, x_{c}) is found by interpolating pixel values of the telephoto image 206. Otherwise, the pixel value of the composite image 208 at position (y_{c}, x_{c}) is found by interpolating pixel values of the wide image 204.

Those skilled in the art will recognize that the above description of producing the values of the composite image 208 using pixel values of the wide image 204 and the telephoto image 206 can be accomplished in many ways. For example, it is easy to pre-calculate the region of pixel locations of the composite image 208 for which the pixel values will be produced by interpolating the telephoto image 206 and the region for which the pixel values will be produced by interpolating the wide image 204. This saves computational cost but produces the same image data.

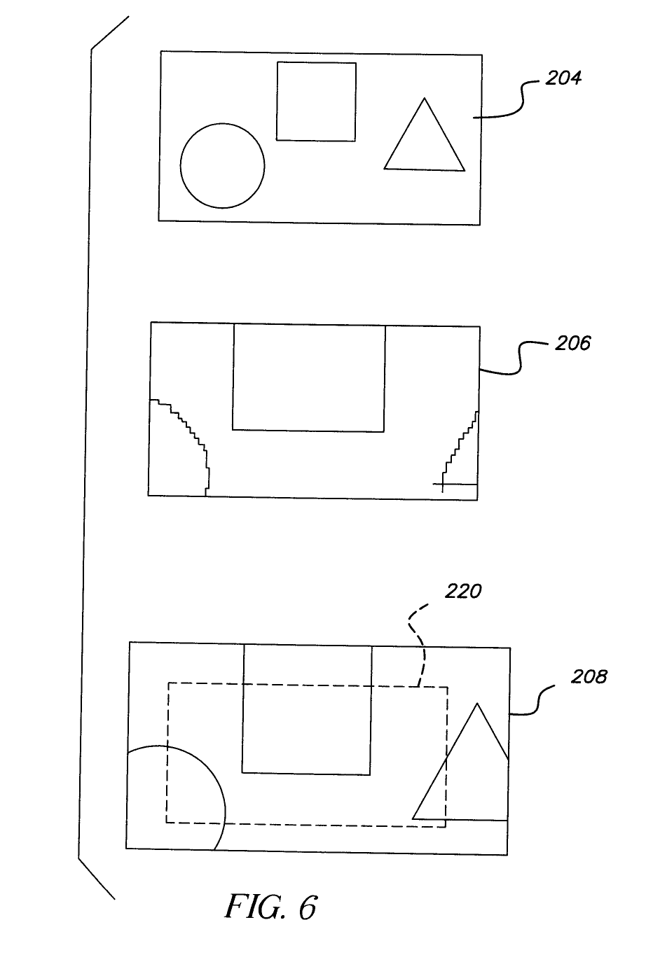

FIG. 6 shows an example set of images. The wide image 204 covers a wide portion of the scene and the telephoto image 206 covers a smaller portion of the scene, but with greater resolution. The produced composite image 208 uses pixel data from the telephoto image 206 for those portions (i.e. the region within the dashed line 220) that are in the view of the telephoto image 206 and uses pixel data from the wide image 204 otherwise (i.e. the region outside the dashed line 220). The dashed line 220 shows where the transition is. Thus, the composite image 208 has higher resolution in the interior and lower resolution on the edges. Since the subject of a photograph, especially in consumer photography, is likely to be near the center of the scene, the subject of the composite image 208 is likely to have the highest resolution. It has also been experimentally determined that the transition within the composite image 208 between pixels derived by interpolating the wide image 204 versus the telephoto image 206 does not product visually objectionable artifacts.

Since lenses 2 and 3 are separated by some distance, it is possible that objects very close to the camera will appear to have a discontinuity at the transition. In this case, it is possible to use standard image processing techniques to find objects that are close to the camera and to process these regions in a fashion that does not produce a discontinuity artifact. For example, the pixel values of the composite image 208, for objects that are close to the camera and span the transition region, can be determined by interpolating the wide image 204. A true depth map can also be created and used by the image resampler 214 to sample the appropriate locations within the telephoto image 206 and the wide image 204. In this case, the registration model is no longer a simple scale translation model.

A further feature of the present invention is that the composite image 208 can be stored on the camera without digital zooming. Therefore, digital zooming of the composite image 208 can be (lone later, during post processing, to create an image for use by the operator for printing or sharing. The composite image 208 can be formed during image processing on the camera or later during post processing when the images have been offloaded from the camera. To enable the composite image to be formed during post processing, the wide image 204 and the telephoto image 206 must both be stored at the time of image capture.

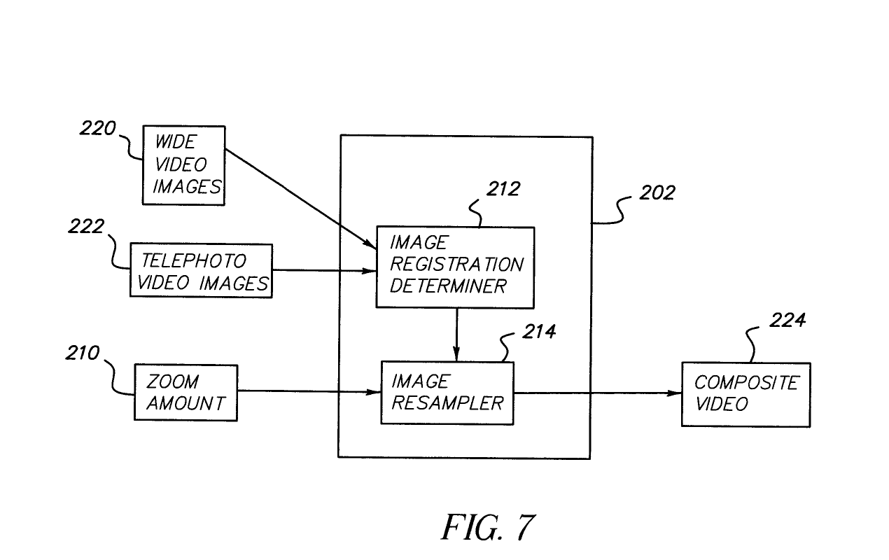

The invention can also be applied to a series of sequential images as in a video. Referring to FIG. 7, in the case of video, two sets of video images, wide video images 220 and telephoto video images 222 are captured substantially simultaneously from the two lenses 2 and 3 or 2 and 4 and the two image sensors 12 and 14 providing video images from a short focal length lens 2 and a zoom lens 3 or a longer second focal length lens 4. The composite video 224 is formed by combining the two sets of video images 220 and 222. The composite video 224 can be formed during image processing on the camera and stored on the camera or the composite video 224 can be formed later during post processing when the images have been offloaded from the camera. To enable the composite video 224 to be formed during post processing, the wide video images 220 from the short focal length lens 2 and the telephoto video images 222 from the zoom lens 3 or the longer focal length lens 4 must both be stored at the time of image capture. Digital zoom of the video images can be accomplished on the camera during capture, or on the camera after capture, or during post processing after the composite video 224 has been offloaded from the camera or during post processing when the composite video 224 is being formed.

The processed digital image file is provided to a memory card interface 52, which stores the digital image file on the removable memory card 54. Removable memory cards 54 are one type of removable digital image storage medium, and are available in several different physical formats. For example, the removable memory card 54 can include (without limitation) memory cards adapted to well-known formats, such as the Compact Flash, SmartMedia. MemoryStick, MMC, SD, or XD memory card formats. Other types of removable digital image storage media, such as magnetic hard drives, magnetic tape, or optical disks, can alternatively be used to store the still and motion digital images. Alternatively, the digital camera 10A can use internal non-volatile memory (not shown), such as internal flash EPROM memory to store the processed digital image files. In such an embodiment, the memory card interface 52 and the removable memory card 54 are not needed.

The image processor 50 performs various image processing functions, including color interpolation followed by color and tone correction, in order to produce rendered sRGB image data. The rendered sRGB image data is then JPEG compressed and stored as a JPEG image file on the removable memory card 54. The rendered sRGB image data can also be provided to a host PC 66 via a host interface 62 communicating over a suitable interconnection, such as a SCSI connection, a USB connection or a Firewire connection. The JPEG file uses the so-called “Exif” image format defined in “Digital Still Camera Image File Format (Exit)” version 2.1, July 1998 by the Japan Electronics Industries Development Association (JEIDA), Tokyo, Japan. This format includes an Exif application segment that stores particular image metadata, including the date or time the image was captured, as well as the lens f/number and other camera settings.

It should be noted that the image processor 50, although typically a programmable image processor, can alternatively be a hard-wired custom integrated circuit (IC) processor, a general purpose microprocessor, or a combination of hard-wired custom IC and programmable processors.

The image processor 50 also creates a low-resolution “thumbnail” size image, which can be created as described in commonly-assigned U.S. Pat. No. 5,164,831, entitled “Electronic Still Camera Providing Multi-Format Storage Of Full And Reduced Resolution Images” issued in the name of Kuchta, et al., the disclosure of which is herein incorporated by reference. After images are captured, they can be quickly reviewed on a color LCD image display 70 by using the thumbnail image data. The graphical user interface displayed on the color LCD image display 70 is controlled by the user controls 42.

In some embodiments of the present invention, the digital camera 10A is included as part of a camera phone. In such embodiments, the image processor 50 also interfaces to a cellular processor 90, which uses a cellular modem 92 to transmit digital images to a cellular network (not shown) using radio frequency transmissions via an antenna 94. In some embodiments of the present invention, the image capture assembly 1 can be an integrated assembly including the lenses 2 and 3, the image sensors 12 and 14, and zoom and focus motors 5. In addition, the clock drivers 13 and 15, as well as the analog signal processors 22 and 24, the digital multiplexer 37, and the A/D converters 34 and 36, can be part of the integrated assembly.

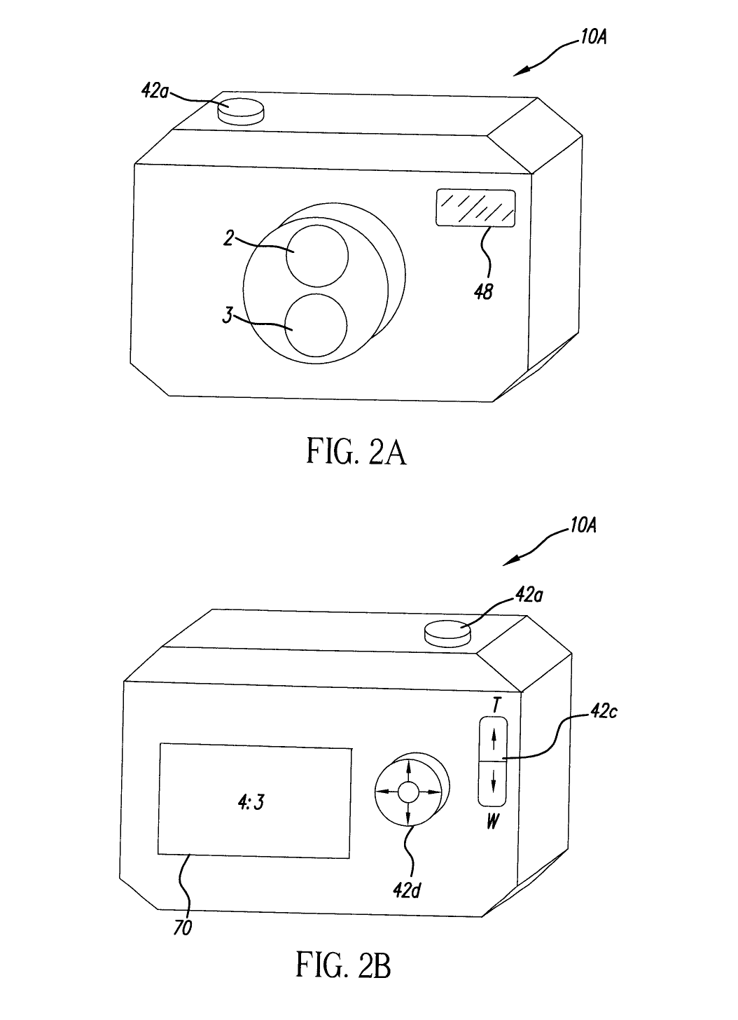

FIGS. 2A and 2B show perspective views of the digital camera 10A and 10B described in relation to FIGS. 1A and 1B respectively. FIG. 2A is a front view of the digital camera 10A, showing the fixed focal length lens 2, and the zoom lens 3 and flash 48. The fixed focal length lens 2 is preferably a very short focal length lens so that the camera can be very thin. Other lens focal lengths and lens type constructions are within the scope of the invention.

FIG. 2B is a rear view of the digital camera 10A. The various operator controls for the user interface are shown as 42a, 42c and 42d. The display for viewing the images is shown as 70. The aspect ratio of the display is typically 4:3 but can be any other ratio.

In a further preferred embodiment, as shown in FIG. 1B, digital camera 10B includes an adjustable focal lens system with two fixed focal length lenses 2 and 4, each providing an image to a corresponding image sensor 12 and 14. The digital camera 10B is capable of simultaneous image capture on both image sensors 12 and 14. The two fixed focus lenses are selected to provide a substantial zoom range, for example, 3:1 wherein the focal length of the second fixed focal length lens 4 is 3× as long as the fixed focal length lens 2. As in digital camera 10A, a composite image is constructed from the two images captured on images sensors 12 and 14. Digital zoom is applied to the composite image between the image captured with the short fixed focal length lens 2 on first image sensor 12 and the image captured with the longer second fixed focal length lens 4 on second image sensor 14. The zoom control 42c can provide zoom settings over the zoom range, for example, from 1 to 3. The remaining aspects of the digital camera 10B are similar to the digital camera 10A shown in FIG. 1A, and retain the same reference characters. Reference is therefore made to FIG. 1B for further description of these aspects of the digital cameras 10B.

A number of advantages can be obtained by use of the fixed focal length lenses in digital camera 10B. The aperture of each lens can be kept quite large (e.g., f/2.8 at least for the widest angle lens), thereby providing a high speed, low light lens. In addition, the image quality of the optical assembly can be kept higher and at a lower manufacturing cost than for a comparable zoom lens. When digital zooming is employed, there are no moving parts for the zoom—even though there are multiple zoom settings—and the zoom is completely silent and relatively fast in zoom focal length transitions. In addition, the overall size of the image module including both fixed focus lenses and both image sensors is very compact which makes this embodiment important for cell phone cameras and other applications in which size is critical.

In many of the foregoing embodiments, digital zooming is used. Digital zooming is a well-known process and can be constructed using a variety of techniques. One such digital zooming capability is described in commonly-assigned pending U.S. Patent Application Publication No. 2003/0202113, “Electronic Still Camera and Image Processing Method” filed on Aug. 1, 2002 in the name of Sumito Yoshikawa and which is incorporated herein by reference. For the type of system disclosed in this pending patent application, as well as for the system according to the present invention, the image sensor includes an array of discrete light sensitive picture elements overlaid with a color filter array (CFA) pattern to produce color image data corresponding to the CFA pattern. The output data from the image sensor is applied to an analog signal processing (ASP) and analog/digital (A/D) conversion section, which produces digital CFA data from the color image data.

The resultant digital data is applied to a digital signal processor, such as the image processor 50 (referring to FIGS. 1A and 1B of the present invention), which interpolates red, green, and blue (RGB) color image data for all of the pixels of the color image sensor. The CFA image data represents an image of a fixed size, such as 2048 columns of pixels×1536 rows of pixels. A digitally zoomed image is created by taking the center section of the CFA image data and interpolating any additional pixels that fall in between the pixels provided by the image sensor. For example, a 2:1 digital zoom is provided by using only the center 1024 columns×768 rows of the CFA image data and interpolating one additional row and column in between each of the rows and columns of the center CFA image data so as to enlarge the center of the image. The output of the image processor 50 is a color interpolated and digitally zoomed image, with 2048 columns and 1536 rows of RGB data, provided from the center 1024 columns×768 rows of CFA image data.

To operate the present imaging system according to the teaching of the aforementioned Yoshikawa patent, the user operates the digital camera, e.g., the digital camera 10A or 10B, to take pictures while observing the image on the color LCD image display 70. The digital CFA image for each of the captured images is processed by the image processor 50 and displayed in a “thumbnail” or subsampled format in the preview step. If the observed zoom amount is not desired, the user then changes the zooming/cropping setting in a zoom selection or cropping step by using the zoom button 42c. For example, a 2.5:1 overall zoom setting can be provided by using the center 1638 columns×1230 rows from the 2048 columns×1536 rows of CFA image data. The composite image will then contain more columns and rows of image data in the central area where the image captured with the longer focal length lens is located.

In a preferred embodiment, the image produced on the color LCD image display (70) is derived from the composite image containing data from both the wide image and the telephoto image. In an alternative embodiment, the image on the color LCD image display can be derived entirely from the wide image to reduce the computational requirements for producing the LCD image.

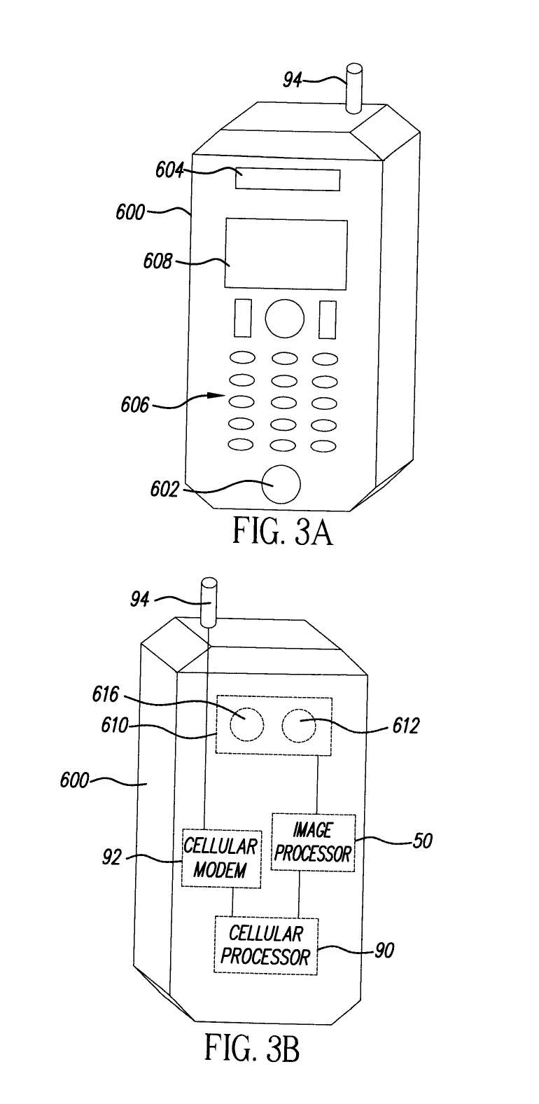

Multiple lenses and multiple sensors, and the use of an integrated image capture assembly, can be adapted for use in a cell phone of the type having a picture taking capability. Accordingly, and as shown in FIG. 3A, a cell phone 600 includes a phone stage comprising a microphone 602 for capturing the voice of a caller, related electronics (not shown) for processing the voice signals of the caller and the person called, and a speaker 604 for reproducing the voice of the person called. A keypad 606 is provided for entering phone numbers and image capture commands and a (LCD) display 608 is provided for showing phone-related data and for reproducing images captured by the phone or received over the cellular network. The rear view of the cell phone 600 shown in FIG. 3B identifies some of the internal components, including a cellular image capture assembly 610 connected via the image processor 50 (as shown in FIGS. 1A and 1B) to a cellular processing stage comprising the cellular processor 90 and the cellular modem 92. The cellular processor 90 receives and processes the image data from the image processor 50 and the voice data captured by the microphone 602, and transfers the image and voice data to the cellular modem 92. The cellular modem 92 converts the digital image and voice data into the appropriate format for transmission by the antenna 94 to a cellular network.

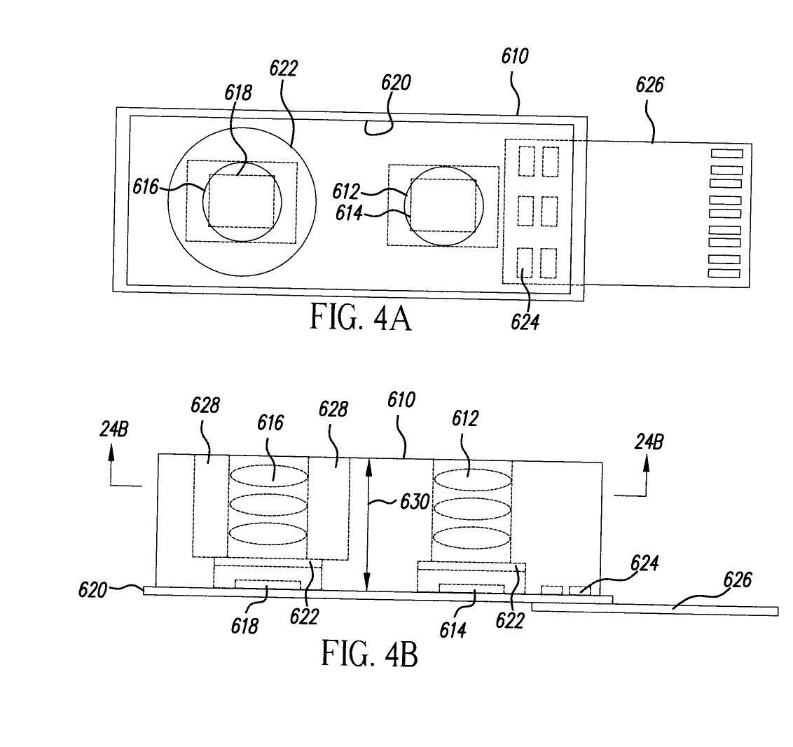

The cellular image capture assembly 610 as shown in FIGS. 4A and 4B, where FIG. 4B is a top view of the cellular image capture assembly 610 taken along the lines 24B-24B in FIG. 4A, comprises an integrated packaging of the optical and imaging components on a common substrate 620. More specifically, the cellular image capture assembly 610 includes a first fixed focal length lens 612 and a first image sensor 614, and a second fixed focal length lens 616 and a second image sensor 618. The first fixed focal length lens 612, preferably a fixed focal length wide angle lens, forms an image on the first image sensor 614, and the second fixed focal length lens 616, preferably a fixed focal length telephoto lens with a longer focal length, forms an image on the second image sensor 618. Both of the lenses are oriented in the same direction in order to form images of the same portion of the overall scene in front of them, but different fields of view.

Each fixed focal length lens 612 and 616 and each associated image sensor 614 and 618 are mounted to the substrate 620 with an IR cut filter 622 in between to reduce the incidence of IR radiation on the image pixels. Electronic components 624, such as resistors, capacitors and power management components, are also mounted on the substrate 620. A flex connector 626 is used to take the image data from the substrate 620. The data can be raw image data or, if suitable processors (not shown) are on board the substrate 620, YUV image data or JPEG image data. Moreover, the image processor 50 can provide digital zooming between the wide angle and the telephoto focal lengths; the user can initiate such zooming via a user interface displayed on the (LCD) display 608 and by keying appropriate buttons on the keypad 606. Furthermore, the wide-angle image sensor 614 can have high resolution, e.g., higher than that of the telephoto second image sensor 618, in order to provide a higher quality source image for the digital zooming.

In one embodiment, the wide angle first fixed focal length lens 612 is set to its hyperfocal distance, which means it is in focus from a few feet to infinity without need for any focus adjustment by the user. The telephoto second fixed focal length lens 616 is automatically focused by an auto focus subsystem 628 because the hyperfocal distance increases as the focal length increases requiring that the focus be adjusted in order to obtain proper focus for objects at typical (e.g. 4′ to 12′) distances. By using only one focusing subsystem 628 for the telephoto second fixed focal length lens 616, the cost and size can be reduced.

In this embodiment the “z” dimension 630 can be reduced consistent with cell phone layout and architecture. Careful choice of the telephoto focal length, the use of a folded optical path and the size of the sensor can further reduce the “z” dimension 630. For example, the size of the second image sensor 618, and consequently the size of the image that must be produced to fill the sensor, can be made small enough to reduce the focal length to an acceptable “z” dimension 630.

Although not shown in detail in FIGS. 4A and 4B, but similarly, as was explained in connection with FIG. 3, an analog output signal from the first image sensor 614 is amplified by a first analog signal processor and provided to a first A/D converter to produce the first digital image data. The first digital image data is provided to the digital multiplexer and the DRAM buffer memory. Similarly, the analog output signal from the second image sensor 618 is amplified by a second analog signal processor and converted to a second digital image data by a second A/D converter. The second digital image data is then provided to the digital multiplexer and the DRAM buffer memory. The first digital image data and the second digital image data are both provided to an input of the image processor wherein the composite image is formed by combining portions of the two images. Wherein the A/D converters, the digital multiplexer, the DRAM buffer memory, and the image processor are provided as electronic components 624 on the substrate 620. The digital zooming of the composite image is done in accordance with the setting of the zoom control.

It is a feature of the invention that by simultaneously capturing two images, of the same scene but different fields of view and different resolutions, a composite image can be formed without having to account for camera motion or motion within the scene. In the case of photographing objects in a scene that are positioned near the camera, adjustments will have to be made for parallax when the two lenses are separated by a substantial distance. This issue will only surface when objects in the scene are very near to the camera. However, in a further preferred embodiment, the two lenses will share a common optical axis to avoid parallax issues between the two images.

The invention has been described in detail with particular reference to certain preferred embodiments thereof, but it will be understood that variations and modifications can be effected within the spirit and scope of the invention.

### PARTS LIST

2 fixed focal length lens
3 zoom lens
4 second fixed focal length lens
5 zoom and focus motors
6 focus motors
10A digital camera (first embodiment)
10B digital camera (second embodiment)
12 first image sensor
12e first image output signal
13 clock drivers
14 second image sensor
14e second image output signal
15 clock drivers
22 first analog signal processor (ASP1)
24 second analog signal processor (ASP2)
34 first A/D converter
36 second A/D converter
37 digital multiplexer
38 DRAM buffer memory
40 control processor and timing generator
42 user controls
42a shutter button
42c zoom button
42d multi-position selector
46 automatic focus and automatic exposure detectors
48 electronic flash
50 image processor
52 memory card interface
54 removable memory card
56 RAM memory
58 firmware memory
62 host interface
64 interconnection
66 host PC
70 color LCD image display
90 cellular processor
92 cellular modem
94 antenna
202 image compositor
204 wide image
206 telephoto image
208 composite image
210 zoom amount
212 image registration determiner
214 image resampler
220 wide video images
222 telephoto video images
224 composite video
600 cell phone
602 microphone
604 speaker
606 keypad
608 (LCD) display
610 cellular image capture assembly
612 first fixed focal length lens
614 first image sensor
616 second fixed focal length lens
618 second image sensor
620 substrate
622 IR cut filter
624 electronic components
626 flex connector
628 auto focus subsystem
630 z dimension

1. A method of producing a digital image having portions with different resolutions comprising:
(a) simultaneously capturing first and second digital images of the same scene wherein the first digital image is of a larger portion of the scene than the second digital image wherein the second digital image has a higher resolution than the resolution in the first digital image corresponding to the second digital image; and
(b) combining at least a portion of the second digital image into the corresponding portion of the first digital image to thereby provide a digital image having portions with different resolutions.

2. The method of claim 1 further including providing an image capture device having two lens systems and two image sensors, each lens system corresponding to a different one of the image sensors.

3. The method of claim 2 wherein each lens system includes at least one fixed focal length lens.

4. The method of claim 2 wherein one of the lens systems is an adjustable focal lens system.

5. A method for operating an image capture device to produce a digital image having portions with different resolutions comprising:
(a) providing an image capture device having an image processor, two lens systems, and two image sensors, each lens system corresponding to a different one of the lens systems:
(b) operating the image capture device to simultaneously capture first and second digital images of the same scene wherein the first digital image is of a larger portion of the scene than the second digital image wherein the second digital image has a higher resolution than the resolution in the first digital image corresponding to the second digital image; and
(c) using the image processor to stitch at least a portion of the second digital image into a corresponding portion of the first digital image providing a composite digital image having portions with different resolutions.

6. The method of claim 5 further including adjusting the zoom lens prior to image capture.

7. The method of claim 5 wherein each lens system includes at least one fixed focal length lens.

8. The method of claim 5 wherein one of the lens systems is an adjustable focal lens system.

9. The method of claim 5 wherein the two lens systems have a common optical axis.

10. The method of claim 5 wherein element (c) further includes using a zoom amount to stitch the first digital image and the second digital image.

11. The method of claim 5 wherein the composite digital image is a series of video images wherein each digital image in the video has different resolutions.
